(19) United States
(12) Patent Application Publication
(10) Pub. No.: US 2009/0085714 A1
(43) Pub. Date: Apr. 2, 2009

(54) THERMISTOR

(75) Inventor: Masaaki YAMASHITA, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/238,554

(22) Filed: Sep. 26, 2008

(30) Foreign Application Priority Data
Sep. 28, 2007 (JP) P2007-255600

(51) Int. Cl. H01C 7/02

(52) U.S. Cl. 338/22 R

(57) ABSTRACT

A thermistor is provided that is capable of sufficiently protecting a thermistor element without increasing the thickness of the element and that prevents separation of the sealed section during installation and shipment. A thermistor 10 includes a thermistor layer 2 composed of conductive particles dispersed in a matrix resin; paired electrodes 1 facing each other and sandwiching the thermistor layer 2, the peripheries of the paired electrodes 1 protruding from the thermistor layer 2 in the planar direction; and a sealing resin 3 surrounding the thermistor layer 2 within an area where the paired electrodes 1 overlap with each other.

### BACKGROUND OF THE INVENTION

1. Field of Invention

The present invention relates to a thermistor and, more specifically, relates to a single-plate organic positive-temperature-coefficient thermistor having a structure in which a thermistor layer is interposed between paired electrodes.

2. Description of the Related Art

Among known positive-temperature-coefficient (PTC) thermistors is known an organic PTC thermistor of which a thermistor element having PTC characteristics comprises a matrix resin and conductive particles dispersed therein. A PTC thermistor having a single-plate structure in which the thermistor element is interposed between the paired electrodes. In such a thermistor, the conductive particles form a conductive path at normal temperature. This ensures conductivity in the thermistor element. However, when the temperature rises by a certain amount, the conductive path tough the conductive particles is cut off due to thermal expansion of the matrix resin, and thus, the thermistor functions as an insulating device.

With such a thermistor, the conductive particles contained in the thermistor element are oxidized by coming into contact with oxygen and other components in the air. As a result, the resistance increases undesirably in a normal condition, in some cases. In order to prevent contact of the thermistor element with air, a conventional thermistor element, which is interposed between paired electrodes, has been protected by resin. For example, Japanese Unexamined Patent Application Publication No 2006-121049 discloses an electric device that is composed of a heat-curable oxygen barrier material on an exposed surface of a conductive polymer layer separating first and second electrodes. Japanese Unexamined Patent Application Publication No. 2007-180382 discloses a PTC device having a protective layer formed of curable material comprising an epoxy resin composition that seals the PTC element and paired electrodes in contact with the PTC element.

### SUMMARY OF THE INVENTION

The sealing described above can prevent the thermistor element from coming into contact with air and thus from degrading due to oxidation. However, the method of sealing according to the conventional technology sometimes causes separation of the sealed section during, for example, installation and/or shipment of the thermistor because the section sealed with resin is exposed to the surface of the thermistor. To prevent contact with oxygen more effectively, the sealed section should be thicker. However, with the above-described method in which resin is applied to the surface of the thermistor, it is difficult to apply a resin layer thicker than a conventional one. Therefore, it is difficult to improve the oxygen blocking characteristic. The method of sealing a thermistor inside resin in Japanese Unexamined Patent Application Publication No. 2007-180382 can solve these problems. However, when the thickness of the sealing section increases, the overall thickness of the device also undesirably increases due to the resin.

Accordingly, the present invention has been made to solve the problems described above, and it is an object of the present invention to provide a thermistor that can surely protect a thermistor element without increasing the thickness of the element and that can prevent separation of the sealed section during installation and shipment.

To achieve this object, a thermistor according to the present invention includes a thermistor layer comprising conductive particles dispersed in a matrix resin; paired electrodes facing each other and sandwiching the thermistor layer, the peripheries of the paired electrodes protruding from the thermistor layer in the planar direction; and a sealing resin surrounding the thermistor layer within an area where the paired electrodes overlap with each other.

With the thermistor according to the present invention having such a configuration, the thermistor layer is interposed between the electrodes that are larger than the thermistor layer, and sealing resin is disposed in the area between the electrodes, protruding from the thermistor layer. Therefore, the section sealed by sealing resin is not exposed, unlike conventional technology, and separation of the sealed section is less likely to occur during installation and shipment. Since the sealing resin is disposed between the electrodes in the protruding area, the sealed section can be easily thickened and an excellent oxygen blocking characteristic can be easily achieved, compared to the conventional technology in which resin is applied to the side surface of the device. Furthermore, the sealing resin disposed between the electrodes does not cause an increase in the thickness due to sealing.

A thermistor according to the present invention includes a thermistor layer comprising conductive particles dispersed in a matrix resin; paired first electrodes facing each other and sandwiching the thermistor layer; paired second electrodes disposed outside the first electrodes and facing each other so as to sandwich the thermistor layer, the peripheries of the second electrodes protruding from the thermistor layer and the first electrodes in the planar direction; and a sealing resin surrounding the thermistor layer within an area where the paired second electrodes overlap with each other.

With the thermistor according to the present invention having such a configuration, the thermistor layer disposed between the paired first electrodes is sandwiched between the second electrodes larger than the thermistor layer and the first electrodes, and the sealing resin is disposed in the area between the second electrodes protruding from the first electrodes and the thermistor layer. Since the section sealed by the sealing resin is therefore not exposed, like the configuration described above, the thickness of the sealed section can be easily increased without a significant increase in the thickness of the thermistor due to sealing.

In particular, the thermistor having such a configuration includes a thermistor layer interposed between first electrodes, and second electrodes that are disposed outside the first electrodes. Therefore, the thermistor layer can be sealed with the second electrodes and sealing resin after sufficiently bonding the thermistor layer and the first electrodes. In this way, reliable electric connection between the thermistor layer and the electrodes can be achieved, and the thermistor layer can be protected from oxygen and other components.

In the thermistor according to the present invention, it is preferable that the thickness of the sealing resin from the thermistor layer side to the opposite side be in the range of 0.5 and 2.0 mm.

When the thickness of the sealing resin is within this range, permeation of oxygen and other components can be more reliably prevented, and a decrease in the characteristic due to the thermistor layer contacting oxygen and other components.

With the thermistor according to the present invention, the thermistor element is sufficiently protected without increasing the thickness of the device, and separation at the sealed section is less likely to occur during installation and shipment.

### BRIEF DESCRIPTION OF THE DRAWINGS

FIG. 1 is an exploded perspective view of the configuration of a thermistor according to a first embodiment.

FIG. 2 is a longitudinal cross-sectional view of the configuration of the thermistor according to the first embodiment.

FIG. 3 is an exploded perspective view of the configuration of a thermistor according to a second embodiment.

FIG. 4 is a longitudinal cross-sectional view of the configuration of the thermistor according to the second embodiment.

### DESCRIPTION OF THE PREFERRED EMBODIMENTS

Embodiments of the present invention will be described below with reference to the accompanying drawings. In the descriptions of the drawings, the same elements are represented by the same reference numerals, and the same description is not repeated.

In the following, preferred embodiments of a thermistor and a method of producing the thermistor will be described. However, the present invention is not limited to the embodiments, and various modifications may be made within the scope of the invention.

### First Embodiment

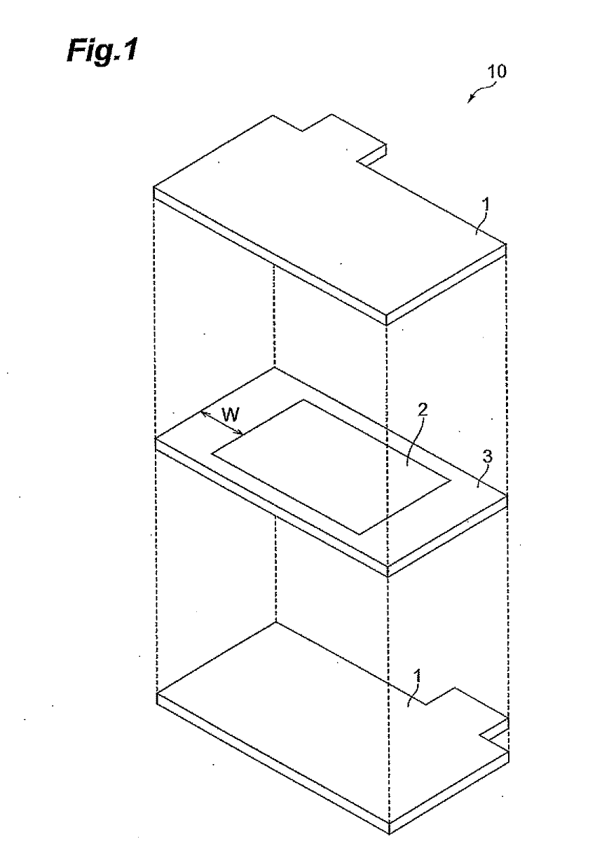

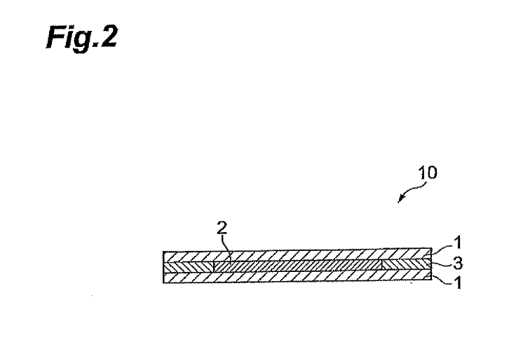

FIG. 1 is an exploded perspective view of the configuration of a thermistor according to a first embodiment. FIG. 2 is a longitudinal cross-sectional view of the configuration of the thermistor according to the first embodiment.

As shown in the drawings, a thermistor 10 according to this embodiment includes a thermistor layer 2 interposed between paired electrodes 1 and is a flat rectangular solid. A sealing resin 3 surrounds the thermistor layer 2 between the paired electrodes 1. If necessary, the thermistor 10 may further include leads (not shown) electrically connected to the electrodes 1. Such a thermistor 10 can be suitably used, for example, as an overcurrent/overheat protecting element, a self-regulating heating element, or a temperature sensor.

Each of the paired electrodes 1 is shaped into a plate or foil. According to this embodiment, a protrusion that functions as a connection terminal for an external unit is provided on one side of the electrode 1. The two electrodes 1 have substantially the same shape, except for the protrusions. The electrodes 1 are disposed such that the portions except for these protrusions are arranged in the opposite directions. The protrusions of the opposing paired electrodes 1 are arranged such that they protrude from the same side of the thermistor 10 but do not overlap each other. The paired electrodes 1 in the thermistor 10 are larger than the thermistor layer 2 in the direction of the layering of the electrodes 1 and the thermistor layer 2. In addition, the circumferential sections (peripheries) of the electrodes 1 protrude further outside than the periphery of the thermistor layer 2.

In each electrode 1, the surface that faces the thermistor layer 2 may be roughened. This improves the adhesiveness between the electrodes 1 and the thermistor layer 2 by an anchor effect, thus enabling a good electrical connection therebetween. Such roughening may be performed over the entire surface of the electrode 1 facing the thermistor layer 2 or may be performed on only the area that is to come into contact with the thermistor layer 2.

Such electrodes 1 are composed of a conductive material that can function as electrodes of a thermistor. Examples of the conductive material may include metals, such as nickel, silver, gold, copper, and aluminum, and alloys of these metals. In particular, nickel (Ni) is preferable because it lowers the resistance of the electrodes 1 and is relatively inexpensive. The electrodes 1 preferably comprise a metal foil. The thickness of the metal foil is preferably 1 to 100 μm and more preferably 1 to 50 μm to reduce their weight. When leads are connected to the electrodes 1, the shape and material of the leads are not limited so long as they are electrically conductive and are capable of emitting or injecting a charge to or from an external unit.

The thermistor layer 2 is in contact with the two paired electrodes 1 in the area where these electrodes 1 overlap with each other. As described above, the electrodes 1 are disposed such that their circumferential sections protrude further than the thermistor layer 2 in the planar direction. In other words, the thermistor layer 2 is disposed inside an imaginary plane connecting the circumferential sections (peripheries) of the facing electrodes 1.

In the thermistor 10, it is preferable that the distance from the periphery of the thermistor layer 2 to the imaginary plane be 0.1 mm or more at the shortest area, more preferably be 0.2 to 5 mm, and even more preferably be 0.5 to 2 mm. If this distance is too short, the sealing resin 3, which is described below, cannot have a sufficient thickness, thus reducing the blocking effect of oxygen and other components in the air compared to when the distance satisfies the above-mentioned values. In contrast, if this distance is too long, the size of the thermistor 10 becomes large relative to the acquired characteristics. This may be disadvantageous on installation.

The thermistor layer 2 is composed of conductive particles dispersed in a resin. The resin contained in the thermistor layer 2 functions as a matrix resin and is composed of a curable material that can expand by heat, such as a thermoplastic resin or thermosetting resin. As such a matrix resin, any known matrix resin for organic PTC thermistors may be used. Examples of thermoplastic resins include polyolefins (for example, polyethylene), copolymers (for example, ethylene-vinyl acetate copolymer) of one or more olefins (for example, ethylene and propylene) and one or more olefinic unsaturated monomers containing polar groups, polyhalogenated vinyls and polyhalogenated vinylidenes (for example, polyvinyl chloride, polyvinylidene chloride, polyvinyl fluoride, or polyvinylidene fluoride), polyamides (for example, 12-nylon), polystyrene, polyacrylonitrile, thermoplastic elastomers, polyethylene oxide, polyacetals, thermoplastic modified celluloses, polysulphones, and polymethyl (meth)acrylate.

Examples of thermosetting resins include resins having crosslinkable functional groups, such as epoxy resins, phenolic resins, unsaturated polyester resins, urea-formaldehyde resins, melamine resins, furan resins, and polyurethane resins. The thermosetting resin may contain any curing agent, if necessary. Preferred matrix resins contained in the thermistor layer 2 are thermoplastic resins that satisfactory PTC characteristics. In particular, polyolefins are preferable, and polyethylene is more preferable.

Any conductive particles composed of a conductive material having electric conductivity, can be used without limitation. For example, conductive particles may be composed of carbon black, graphite, metal, or conductive ceramic material. The metal particles may be composed of copper, aluminum, nickel, tungsten, molybdenum, silver, zinc, cobalt or nickel-plated copper powder. The conductive ceramic material may be, for example, TiC or WC.

In particular, metal particles are preferable because the rate of change in the thermistor's resistance can be maintained sufficiently large and the resistance value at room temperature can be reduced. Nickel particles are more preferable because they are chemically stable, e.g. resistive to oxidation. A single type of conductive particles or a combination of two or more different types of conductive particles may be used. The conductive particles may be primary particles or secondary particles, which are formed by aggregation of the primary particles, and may have spikes or other protrusions if necessary.

The thermistor layer 2 may contain conductive particles in an amount sufficient for expressing the PTC characteristics. For example, it is preferable that the amount of conductive particles contained in the thermistor layer 2 be 20% to 50% of the entire volume.

In addition to the matrix resin and conductive particles, the thermistor layer 2 may further contain any low-molecular weight organic compound for the purpose of regulating the operation temperature. In such a case, the low-molecular weight organic compound is preferably a crystalline compound having a molecular weight of 1,000 or less. The low-molecular weight organic compound is preferably solid at normal temperature (approximately 25° C.). The low-molecular weight organic compound preferably has a melting point (mp) between 40° C. and 100° C.

Examples of preferable low-molecular organic compounds include hydrocarbons (for example, linear alkane hydrocarbons with a carbon number of 22 or larger), fatty acids (for example, fatty acids of linear alkane hydrocarbons with a carbon number of 22 or larger), fatty acid esters (for example, methyl esters of saturated fatty acids derived from saturated fatty acid with a carbon number of 20 or larger and lower alcohols, such as methyl alcohol), fatty acid amides (for example, saturated fatty acid primary amides with a carbon number of 10 or smaller or unsaturated fatty acid amides, such as oleic amide or erucic amide), aliphatic amines (for example, aliphatic primary amines with a carbon number of 16 or larger) and higher alcohols (specifically, n-alkyl alcohols with a carbon number of 16 or larger). The low-molecular weight organic compounds may be used alone or in combination of two or more different types, depending on, for example, the operation temperature. Wax or fat containing low-molecular weight organic compounds as constituents may also be used.

Examples of wax containing low-molecular weight organic compounds include natural waxes such as plant-derived wax, animal-derived wax, and mineral-derived wax. Typical examples of such waxes include petroleum-based waxes, such as paraffin wax and microcrystalline wax. Examples of fat containing low-molecular weight organic compounds include oil and fat.

The sealing resin 3 surrounds the periphery of the thermistor layer 2 inside the area where the paired electrodes 1 face each other. The sealing resin 3 is in contact with both the electrodes 1 at the entire circumference of the sealing resin 3. In this way, the sealing resin 3 seals the thermistor layer 2 together with the electrodes 1 and bonds the paired electrodes 1 to each other. As shown in FIG. 1, the sealing resin 3 fills up the area from the periphery of the thermistor layer 2 to the imaginary plane connecting the circumferential sections of the facing electrodes 1 and does not protrude from the imaginary plane.

The thickness of the sealing resin 3 from the thermistor layer 2 to the opposite side is preferably 0.1 mm or more, more preferably between 0.2 and 5 mm, and most preferably between 0.5 and 2 mm. The sealing resin 3, which surrounds the thermistor layer 2, preferably has such a thickness over the entire circumference. This thickness, “w” in FIG. 1, represents the thickness in the planar direction of the electrodes 1. In other words, it is the width in the direction orthogonal to the layering direction of the thermistor 10. The sealing resin 3 having such a thickness can sufficiently block oxygen and other components in the air. When the thickness is smaller than the distance from the periphery of the thermistor layer 2 to the imaginary plane connecting the circumferential sections (peripheries) of the facing electrodes 1, the sealing resin 3 may be provided without limitations with the area where the electrodes 1 overlap each other, so long as the sealing resin 3 surrounds the thermistor layer 2 and has the above-mentioned thickness.

For example, the sealing resin 3 does not have to be in contact with the sealing resin 3, unlike the drawing. So long as the sealing resin 3 surrounds the thermistor layer 2 together with the paired electrodes 1, the sealing resin 3 may be provided a certain distance away from the thermistor layer 2. However, it is preferable to provide the sealing resin 3 so as to be in contact with at least a part of the periphery of the thermistor layer 2 in order to more reliably block oxygen and other components from the thermistor layer 2. It is more preferable to provide the sealing resin 3 so as to be in contact with the entire periphery.

The sealing resin 3 is formed of any cured resin that can sufficiently block oxygen and other components in the air in the cured state. Examples of the sealing resin 3 include epoxy resins, ethylene-vinyl alcohol copolymer resins, and polyamide resins.

In particular, it is preferable that the sealing resin 3 be composed of a cured epoxy resin composition including an epoxy resin and a thiol-based curing agent, since degradation of the thermistor layer 2 can be significantly reduced by satisfactorily preventing the permeation of oxygen and other components from the outside. Such an epoxy resin composition has high adhesiveness with the electrodes 1, and thus can improve the reliability of the thermistor 10 by preventing separation of the opposing electrodes 1.

The epoxy resin contained in the epoxy resin composition is not limited and any type of epoxy resin fond by processes such as a one-stage process, a two-stage process, and an oxidation process can be used. Examples of suitable epoxy resin include bisphenol A epoxy resins, bisphenol F epoxy resins, glycidyl aliphatic amines, such as tetraglycidyl m-xylenediamine, glycidyl aromatic amines, such as tetraglycidyl-diaminophenylmethane, and aminophenol epoxy resins.

Any thiol-based curing agent having two or more thiol groups can be used without limitation. Preferable examples of thiol-based curing agents include aliphatic polythioesters, such as pentaerythritol tetrathioglycolate and trimethylolpropane tris-thiopropionate, aliphatic thioethers, and polythioethers containing aromatic rings. The amount of the thiol-based curing agent contained in the epoxy resin composition may be determined on the basis of the stoichiometric ratio to the epoxy resin.

It is preferable that the epoxy resin composition further contains an amine compound having a secondary or tertiary amino group. It is preferable that the amine compound be aromatic amine or aliphatic amine, amine-epoxy adduct, imidazole, or imidazole adduct. In addition to the components mentioned above, the epoxy resin composition may further contain fillers, such as silica, mica, and talc particles, inorganic salts, such as magnesium hydroxide and aluminum hydroxide, other curing agents or curing accelerators, such as carboxylic acids or phenol, and solvents for adjusting the viscosity of the resin composition.

The thermistor 10 having the above-described configuration is provided by, for example, a process described below. First, a sheet that is composed of conductive particles dispersed a matrix resin is provided to form a thermistor layer 2. In the case of a thermoplastic resin, this sheet is prepared by mixing and kneading the resin and conductive particles and then heat-pressing the kneaded mixture. In the case of a thermosetting resin, the sheet is prepared by mixing uncured resin and conductive particles, sheeting the mixture, and curing the sheet. If necessary, the resulting sheet may be cut into pieces having sizes suitable for forming the thermistor layer 2.

Next, the sheet is interposed between, for example, paired conductive sheets for electrodes 1. The sheets are hot-pressed in the laminated direction, thereby the sheet for the thermistor layer 2 and the conductive sheets are bonded together. The conductive sheets used are larger than the sheet for the thermistor layer 2. In the bonding of the sheets, the entire circumferences of the conductive sheets protrude outside the sheet for the thermistor layer 2. In this way, a device is composed of the paired electrodes 1 and the thermistor layer 2, which is disposed inside the area where the electrodes 1 overlap with each other.

Then, the sealing resin 3 is provided in the area where the electrodes 1 overlap with, between the paired electrodes 1, and in the area outside the thermistor layer 2. When the sealing resin 3 is formed of, for example, a thermosetting resin, the sealing resin 3 can be formed by injecting a curable resin into the areas and curing the curable resin. When an epoxy resin composition described above is used, the epoxy resin composition can be cured by heating the entire device after injecting the epoxy resin composition.

A preferred process of producing the thermistor 10 has been descried above. However, the process in the present invention is not limited to such a process, and various modifications may be made depending on the properties of the materials to be used. For example, instead of forming a sheet first, the thermistor layer 2 may be formed by injecting a material for the thermistor layer 2 between the paired electrodes 1 (conductive sheets) opposing each other. When the matrix resin contained in the thermistor layer 2 is a thermoplastic resin, a sheet for the thermistor layer 2 may be produced from a raw resin material, such as monomer or oligomer, and a resin may be produced from the raw material through polymerization by heat or light after the sheet is disposed between the electrodes 1.

When the raw material for the sealing resin 3 is sufficiently viscous, the sealing resin 3 can be formed by disposing the sheet for the thermistor layer 2 on one of the electrodes 1 (conductive sheet), applying the raw material of the sealing resin 3 around the sheet, bonding the other electrode 1, and curing the applied raw material.

### Second Embodiment

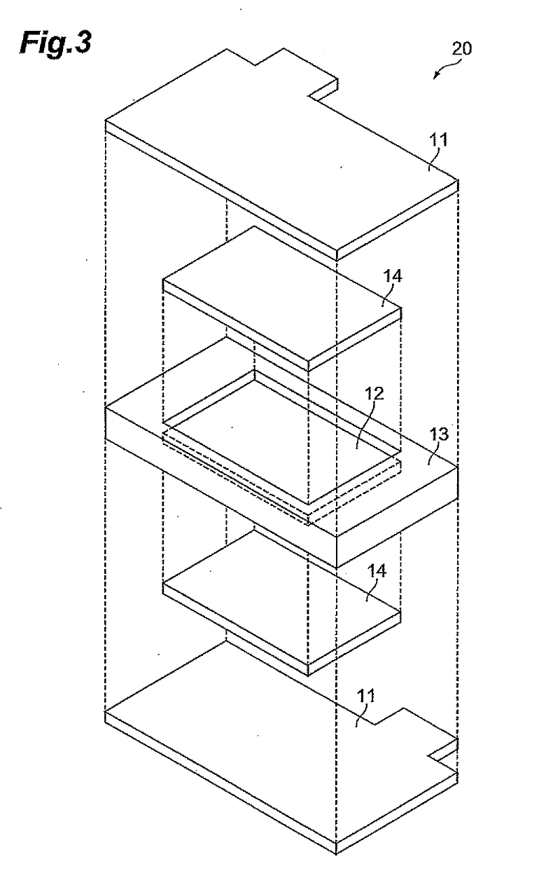

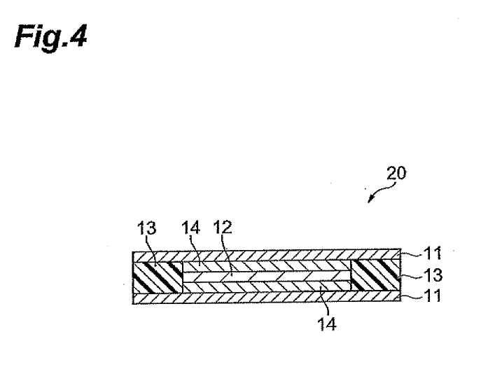

FIG. 3 is an exploded perspective view of the configuration of a thermistor according to a second embodiment. FIG. 4 is a longitudinal cross-sectional view of the configuration of the thermistor according to the second embodiment.

As shown in the drawings, a thermistor 20 according to this embodiment includes a thermistor layer 12 and paired first electrodes 14 sandwiching the thermistor layer 12, and paired second electrodes 11 disposed outside the respective first electrodes 14 so as to sandwich the thermistor layer 12. The entire thermistor 20 is a flat rectangular solid. A sealing resin 13 is disposed in an area outside the thermistor layer 2 interposed between the paired second electrodes 11.

In the thermistor 20, the first electrodes 14 and the second electrodes 11 may be composed of the same material as that of the electrodes 1 in the first embodiment, and the thermistor layer 12 may be composed of the same material as that of the thermistor layer 2 in the first embodiment. The first electrodes 14 and the second electrodes 11 may be composed of the same material or different materials. However, it is preferable that the second electrodes 11 be composed of metals, such as iron, copper, aluminum, and nickel, or alloys, such as brass and stainless steel. In particular, brass is preferable because of its excellent corrosion resistance and workability and inexpensiveness.

In the thermistor 20, the paired first electrodes 14 are in contact with the thermistor layer 12 such at the thermistor layer 12 is interposed between the first electrodes 14. The size of the first electrodes 14 may be larger or smaller than the thermistor layer 12 when viewed from the laminated direction. However, it is preferable that the paired first electrodes 14 and the thermistor layer 12 be the same size and shape when viewed from the laminated direction in order to achieve excellent electric connection by high adhesion between the thermistor layer 12 and the first electrodes 14. The surfaces of the first electrodes 14 facing the thermistor layer 12 may be roughened in order to achieve high adhesion with the thermistor layer 12.

Each of the paired second electrodes 11 is disposed on a side, opposite to the thermistor layer 12, of each of the first electrodes 14 and is in contact with the respective first electrode 14. The shape of the second electrodes 11 and the positional relationship between the second electrodes 11 facing each other are the same as those in the first embodiment. The paired second electrodes 11 are larger than the first electrodes 14 and the thermistor layer 12 when viewed from the laminated direction. The circumferential sections (peripheries) of the second electrodes 11 protrude outside the periphery of the thermistor layer 12 and the circumferential sections (peripheries) of the first electrodes 14.

In such a thermistor 20, the thermistor layer 12 is interposed between the first electrodes 14, which are disposed between the second electrodes 11. In addition, the thermistor layer 12 is disposed inside an imaginary plane connecting the circumferential sections peripheries) of the facing second electrodes 11. The preferable distance from the periphery of the thermistor layer 12 to the imaginary plane is the same as that in the first embodiment described above.

The sealing resin 13 surrounds the periphery of the thermistor layer 12 inside the area where the paired second electrodes 11 face each other so as to seal the thermistor layer 12. The sealing resin 13 fills up the area from the periphery of the thermistor layer 12 to the imaginary plane connecting the circumferential sections of the facing second electrodes 11 and does not protrude from the imaginary plane. It is preferable that the thickness of the sealing resin 13 from the thermistor layer 12 side to the opposite side be the same as that in the first embodiment.

When the first electrodes 14 is larger than the thermistor layer 12, as described above, the sealing resin 13 may be provided inside the area between the first electrodes 14. However, in such a case, it is preferable that the sealing resin 13 be in contact with both facing second electrodes 11 so as to achieve satisfactory bonding of the facing second electrodes 11. The sealing resin 13 may be disposed at a certain distance away from the thermistor layer 12 so as to surround the thermistor layer 12. However, it is preferable that the sealing resin 13 be in contact with the thermistor layer 12 in order to reliably prevent permeation of oxygen and other components.

The thermistor 20 having such a configuration can be produced, for example, as follows. First, a sheet is provided to form a thermistor layer 12 as in the first embodiment. Next, the sheet is interposed between paired conductive sheets for first electrodes 14. The sheets are pressure-bonded by, for example, hot-pressing, so as to prepare a laminate composed of the thermistor layer 12 interposed between the paired first electrodes 14. The conductive sheets for the first electrodes 14 may be substantially the same size as the thermistor layer 12.

Then, paired conductive sheets for the second electrodes 11 are provided and are disposed on the outer sides of the first electrodes 14 to sandwich the laminate. The conductive sheets for the second electrodes 11 are larger than those for the thermistor layer 12 and the first electrodes 14. When the conductive sheets are bonded, the entire circumferences of the conductive sheets are disposed such that they protrude outside the above-described laminate. Then, the sealing resin 13 is provided in the area where the paired second electrodes 11 overlap with, between the paired second electrodes 11, and in the area outside the thermistor layer 12. In this way, the thermistor 20 having the above-described configuration is prepared.

According to the second embodiment, the thermistor 20 is prepared by laminating the thermistor layer 12 and the first electrodes 14 by, for example, heat-pressing, cutting the heat-pressed compact into a laminate having a predetermined size, and interposing the laminate between the second electrodes 11. Accordingly, many laminates can be produced at once by, first, heat-pressing large sheets for the thermistor layer 12 and the first electrodes 14 and then cutting the heat-pressed compact. In this way, the thermistor 20 can be produced more efficiently than when individual laminates are heat-pressed, and thus, mass-production becomes easy.

In the thermistor, terminals provided for connection on the outside electrodes (second electrodes 11 in the second embodiment) have various shapes depending on the device to which the thermistor is mounted. Therefore, as described in the second embodiment, by, first, producing laminates having a predetermined shape and then interposing each laminate between the second electrodes 11, mass-production becomes easier than producing thermistors having different-shaped electrodes individually. In this way, the thermistor and the method of producing the thermistor according to the second embodiment are significantly suitable for mass production of thermistors.

As in the second embodiment, when electrodes are provided on the outside of a laminate formed by interposing a thermistor layer between paired electrodes, the inner electrodes (first electrodes) and the outer electrodes (second electrodes) have been generally bonded by soldering. However, in such a case, excess heat was applied to the thermistor during reflow soldering for bonding, resulting in an undesirable increase in resistance. In contrast, according to the second embodiment of the present invention, by providing the second electrodes 11 at a size larger than the thermistor layer 12 and the first electrodes 14, these can be bonded by the sealing resin 13. As a result, the above-mentioned bonding by soldering is not required, and degradation caused by heat generated during the bonding can be prevented.

The method of producing the thermistor 20 is not limited to the above-described method, and various modifications may be made in the same way as the first embodiment. For example, the thermistor layer 12 may be formed by disposing paired first electrodes 14 facing each other, injecting a raw material for the thermistor layer 12 between the first electrodes 14, and polymerizing the raw material. In another embodiment, a sheet for the thermistor layer 12 is formed in an unpolymerized state containing resin; a laminate is formed as described above; and then polymerization is cared out. Alternatively, the sealing resin 13 may be applied to one of the second electrodes 11, instead of injecting it between the paired second electrodes 11.

### EXAMPLES

Examples of the present invention will be described in more detail below. However, the present invention is not limited to these examples.

### (Production of Thermistor)

### Example 1

First, filamentary Ni particles were added to high-density polyethylene (melting point: 130° C., density: 0.92 g/cm³) in an amount equal to 35 volume % of the high-density polyethylene; and the mixture was kneaded for 30 minutes in a Labo Plastmill while being heated at 150° C. to prepare a kneaded material in which Ni particles were dispersed. The resulting kneaded material was formed into a 0.8-mm thick sheet for a thermistor by heat-pressing at 150° C.

Next, the resulting sheet was interposed between two Ni foils, each having one roughened surface; the Ni foils were fixed by heating and pressurizing the entire composite by heat-pressing; and a 0.4-mm thick sheet with Ni foils was produced. This sheet was cut into pieces of 9.0×3.6 mm; then, the pieces were irradiated with radiation to crosslink the high-density polyethylene; and a thermistor element having a configuration in which a thermistor layer is interposed between Ni foils was produced.

Then, the crosslinked thermistor element was interposed between the center areas of two 13.0×8.0 mm brass plates with a thickness of 0.5 mm, then, an epoxy resin composition (AE-10 (product name) manufactured by Ajinomoto Fine-Techno Co., Inc.) containing an epoxy resin and a thiol curing agent was injected, using a dispenser, into an area around the thermistor element between the paired brass plates; and the epoxy resin composition was heated at 80° C. for 30 minutes. The epoxy resin composition was injected so as to fill up an area of approximately 500 μm from the periphery of the thermistor element between the paired brass plates to the peripheries of the brass plates. In this way, a sealing resin composed of cured epoxy resin composition and having a thickness of approximately 500 μm from the thermistor layer side to the opposite side was formed. The thermistor according to Example 1 was produced as described above.

### Example 2

A thermistor according to Example 2 was formed as in Example 1, except for injecting an epoxy resin composition to fill up a 1-mm thick area from the periphery of the thermistor element to the peripheries of the brass plates and forming a sealing resin composed of cured epoxy resin composition and having a thickness of approximately 1 mm from the thermistor layer side to the opposite side.

### Example 3

A thermistor according to Example 3 was formed as in Example 1, except for injecting an epoxy resin composition to fill up a 2-mm thick area from the periphery of the thermistor element to the peripheries of the brass plates and forming a sealing resin composed of cured epoxy resin composition and having a thickness of approximately 2 mm from the thermistor layer side to the opposite side.

### Comparative Example 1

A thermistor according to Comparative Example 1 was produced by forming a thermistor element through the same process as Example 1, applying an epoxy resin composition to a side surface of the thermistor element at a thickness of approximately 20 μm, and curing the epoxy resin composition by heating at 80° C. for 30 minutes.

### Comparative Example 2

A thermistor according to Comparative Example 2 was produced by applying cream solder to the surfaces of the Ni foils of the element after preparation of a thermistor element through the same process as Example 1, by disposing the thermistor element between two 13.0×8.0 mm brass plates with a thickness of 0.5 mm, and by soldering the brass plates to the thermistor element by heating in a reflow oven at 230° C. for 1 minute.

### (Evaluation)

The thermistors according to Examples 1 to 3 and Comparative Examples 1 and 2 were measured using a digital multimeter manufactured by Agilent Technologies, Inc. to determine the resistance values: (1) immediately after producing the thermistors; (2) after heating the thermistors at 100° C. for 5 hours; (3) after leaving the thermistors for 180 days at normal temperature after production; and (4) heating the thermistors at 100° C. for 5 hours after step (3). The force (bonding strength of the brass plates) required for separating the brass plates from each thermistor after the above-mentioned steps was measured using a universal tester manufactured by Shimadzu Corporation. The results are shown in Table 1.

TABLE 1

| | |
|---|---|
| Resistance (mΩ) | Bonding |

| | (1) | (2) | (3) | (4) | Strength |
|---|---|---|---|---|---|
| EXAMPLE 1 | 3 | 5 | 3 | 6 | 1.5 kg |
| EXAMPLE 2 | 3 | 5 | 3 | 6 | 2 kg or more |
| EXAMPLE 3 | 3 | 5 | 3 | 6 | 2 kg or more |
| COMPARATIVE | 3 | 5 | 3 | 12 | 0.1 kg |
| EXAMPLE 1 | | | | | |
| COMPARATIVE | 5 | 8 | 5 | 40 | 2 kg or more |
| EXAMPLE 2 | | | | | |

The thermistors according to Examples 1 to 3 had brass plates (second electrodes in FIG. 3) larger than the thermistor element and had a sealing resin containing an epoxy resin composition in areas on the brass plates around the thermistor element. As shown in Table 1, the resistance values after each step relative to the initial resistance for the thermistors according to Examples 1 to 3 increases less than the resistance values for the thermistors according to the Comparative Examples 1 and 2, which do not have such a configuration. The results elucidate that degradation of the thermistor layer due to outside effects was significantly prevented. The thermistors according to is Examples 1 to 3 have sufficiently high bonding strengths to the brass plates.

1. A thermistor comprising:
a thermistor layer comprising conductive particles dispersed in a matrix resin;
paired electrodes facing each other and sandwiching the thermistor layer, the peripheries of the paired electrodes protruding from the thermistor layer in the planar direction; and
a sealing resin surrounding the thermistor layer within an area where the paired electrodes overlap, with each other.

2. A thermistor comprising:
a thermistor layer comprising conductive particles dispersed in a matrix resin;
paired first electrodes facing each other and sandwiching the thermistor layer;
paired second electrodes disposed outside the first electrodes and facing each other so as to sandwich the thermistor layer, the peripheries of the second electrodes protruding from the thermistor layer and the first electrodes in the planar direction; and
a sealing resin surrounding the thermistor layer within an area where the paired second electrodes overlap with each other.

3. The thermistor according to claim 1,
wherein the thickness of the sealing resin from the thermistor layer side to the opposite side is in the range of 0.5 and 2.0 mm.
